(19) United States
(12) Patent Application Publication
(10) Pub. No.: US 2023/0420866 A1
(43) Pub. Date: Dec. 28, 2023

(54) RADAR SIGNAL DEVICE WHERE A PROJECTION OF A FEED STRUCTURE AT LEAST PARTIALLY OVERLAPS WITH AN OPENING ON A METAL LAYER

(71) Applicant: RichWave Technology Corp., Taipei City (TW)

(72) Inventor: Shih-Kai Lin, Taipei City (TW)

(73) Assignee: RichWave Technology Corp., Taipei City (TW)

(21) Appl. No.: 18/197,736

(22) Filed: May 16, 2023

Related U.S. Application Data
(60) Provisional application No. 63/342,635, filed on May 17, 2022.

(30) Foreign Application Priority Data
Nov. 15, 2022 (TW) 111212500

(51) Int. Cl. H01Q 19/13; H01Q 1/32

(52) U.S. Cl. CPC H01Q 19/136; H01Q 1/3233

(57) ABSTRACT

A radar signal device includes an antenna unit, a transmission circuit and a reception circuit. The antenna unit is used to concurrently transmit a transmission signal and receive a reception signal. The antenna unit includes a metal layer, a first feed structure and a second feed structure. An opening is formed on the metal layer. A first projection of the first feed structure on the metal layer at least partially overlaps with the opening. A second projection of the second feed structure on the metal layer at least partially overlaps with the opening. The antenna unit forms a first radiation pattern used to transmit the transmission signal and a second radiation pattern used to receive the reception signal. An angle between a co-polarized electric field direction of the first radiation pattern and a co-polarized electric field direction of the second radiation pattern is between 45 degrees and 135 degrees.

### CROSS REFERENCE TO RELATED APPLICATION

This application claims the priority benefit of U.S. Provisional Application No. 63/342,635, filed on May 17, 2022, and the priority benefit of Taiwan application serial no. 111212500, filed on Nov. 15, 2022. The content of the application is incorporated herein by reference.

### TECHNICAL FIELD

The disclosure is related to a radar signal device, and more particularly, a radar signal device where a projection of a feed structure at least partially overlaps with an opening on a metal layer.

### BACKGROUND

As the demands for communications increase, the requirements for antenna-related devices also increase accordingly. In the current technology, antenna arrays are often used for implementing an antenna device with high isolation. This will require a large number of components, causing difficulty in reducing the device area, difficulty in using the circuit boards (such as a printed circuit board) and difficulty in reducing the cost.

In addition, patch antennas can be used for signal transmission and reception. However, this can only achieve a unidirectional radiation pattern, resulting in limited detection range and limited application scenarios. Additional components such as antenna couplers must be installed to process signals. Therefore, it is difficult to simplify the antenna structure and improve the antenna performance.

### SUMMARY

An embodiment provides a radar signal device including an antenna unit, a transmission circuit and a reception circuit. The antenna unit is configured to transmit a transmission signal and receive a reception signal concurrently during a time interval. The antenna unit includes a first metal layer, a first feed structure and a second feed structure. A first opening is formed on the first metal layer, and the first opening passes through the first metal layer. The first feed structure is configured to receive a first internal signal, where the transmission signal is generated according to at least the first internal signal. A first projection of the first feed structure on the first metal layer at least partially overlaps with the first opening. The second feed structure is configured to transmit a second internal signal, where the second internal signal is generated according to at least the reception signal. A second projection of the second feed structure on the first metal layer at least partially overlaps with the first opening. The transmission circuit is configured to generate the first internal signal. The reception circuit is configured to generate a processed signal related to the second internal signal. The antenna unit is configured to form a first radiation pattern and a second radiation pattern. The first radiation pattern is used to transmit the transmission signal and has a first co-polarized electric field direction. The second radiation pattern is used to receive the reception signal and has a second co-polarized electric field direction. An angle between the first co-polarized electric field direction and the second co-polarized electric field direction is between 45 degrees and 135 degrees.

Another embodiment provides a radar signal device including an antenna unit, a transmission circuit and a reception circuit. The antenna unit is configured to transmit a transmission signal and receive a reception signal concurrently during a time interval. The antenna unit includes a first metal layer, a first feed structure and a second feed structure. A first opening and a third opening are formed on the first metal layer and pass through the first metal layer. A first feed structure is configured to receive a first internal signal, where the transmission signal is generated according to at least the first internal signal. A first projection of the first feed structure on the first metal layer at least partially overlaps with the first opening. A second feed structure is configured to transmit a second internal signal, where the second internal signal is generated according to at least the reception signal. A second projection of the second feed structure on the first metal layer at least partially overlaps with the third opening. The transmission circuit is configured to generate the first internal signal. The reception circuit is configured to generate a processed signal related to the second internal signal. The antenna unit is configured to form a first radiation pattern and a second radiation pattern. The first radiation pattern is used to transmit the transmission signal and has a first co-polarized electric field direction. The second radiation pattern is used to receive the reception signal and has a second co-polarized electric field direction. An angle between the first co-polarized electric field direction and the second co-polarized electric field direction is between 45 degrees and 135 degrees.

### BRIEF DESCRIPTION OF THE DRAWINGS

FIG. 1 and FIG. 2 illustrate radar signal devices according to different embodiments.

FIG. 3 illustrates that an antenna unit includes the first metal layer and a second metal layer according to another embodiment.

FIG. 4 illustrates a radar signal device according to another embodiment.

FIG. 5, FIG. 6 and FIG. 7 illustrate antenna patterns of the radar signal device in FIG. 4 according to different embodiments.

FIG. 8 illustrates the scattering parameters (S parameters) when the radar signal device in FIG. 1 is used according to an embodiment.

FIG. 9 illustrates a radar signal device according to another embodiment.

FIG. 10 illustrates that an antenna unit includes the first metal layer in FIG. 9 and a second metal layer according to another embodiment.

FIG. 11 to FIG. 15 illustrate radar signal devices according to other embodiments.

FIG. 16 and FIG. 17 illustrate antenna patterns of the radar signal device in FIG. 15 according to different embodiments.

FIG. 18 illustrates the scattering parameters (S parameters) when the radar signal device in FIG. 11 is used according to an embodiment.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

In the text, when it mentions an item A overlaps with an item B, it means the projections of the item A and the item B overlap with one another, where the item A and the item B may or may not touch one another directly.

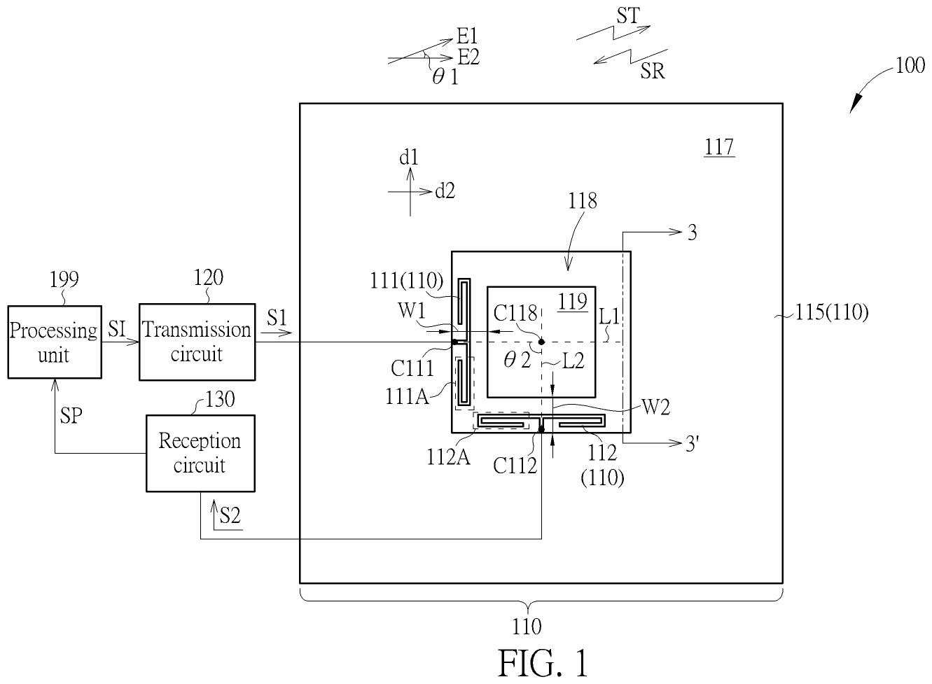

FIG. 1 illustrates a radar signal device 100 according to an embodiment. The radar signal device 100 can include an antenna unit 110, a transmission circuit 120 and a reception circuit 130. In FIG. 1, the antenna unit 110 is illustrated in a top view, and the transmission circuit 120 and the reception circuit 130 are illustrated as a block diagram. FIG. 1 is for illustration instead of showing accurate size and ratio. As shown in FIG. 1, the antenna unit 110 can transmit a transmission signal ST and receive a reception signal SR concurrently during a time interval. The transmission signal ST and the reception signal SR can be wireless signals. The antenna unit 110 can include a first metal layer 115, a first feed structure 111 and a second feed structure 112. A first opening 118 can be formed on the first metal layer 115, and the first opening 118 can pass through the first metal layer 115. The first feed structure 111 and the second feed structure 112 can be formed on the first metal layer 115 to be coplanar with the first metal layer 115. In another embodiment, each of the first feed structure 111 and the second feed structure 112 can be formed on another metal layer different from the first metal layer 115 to be not coplanar with the first metal layer 115. According to some embodiments, the first metal layer 115 can be a ground plane and have a reference voltage level (e.g. 0 volts).

If the first feed structure 111 and the second feed structure 112 are not coplanar with the first metal layer 115, the first internal signal S1 can be transmitted through a transmission line between the first feed structure 111 and the transmission circuit 120, and the second internal signal S2 can be transmitted through a transmission line between the second feed structure 112 and the reception circuit 130. Each of the transmission lines can include a microstrip, an external wire, a coplanar waveguide (CPW), a grounded CPW or another transmission line that can be implemented between the first metal layer 115 and each of the first feed structure 111 and the transmission circuit 120. Each of the microstrip and the CPW can be formed using a conductive layer of a printed circuit board (PCB).

In another embodiment, if the first feed structure 111, the second feed structure 112 and the first metal layer 115 are coplanar, the first internal signal S1 can be transmitted through a CPW between the first feed structure 111 and the transmission circuit 120, and the second internal signal S2 can be transmitted through a CPW between the second feed structure 112 and the reception circuit 130.

A first projection of the first feed structure 111 on the first metal layer 115 can at least partially overlap with the first opening 118. The first feed structure 111 can receive the first internal signal S1, and the transmission signal ST can be generated according to at least the first internal signal S1. A second projection of the second feed structure 112 on the first metal layer 115 can at least partially overlap with the first opening 118. The second feed structure 112 can transmit the second internal signal S2, and the second internal signal S2 can be generated according to at least the reception signal SR. The transmission circuit 120 can generate the first internal signal S1. The reception circuit 130 can generate a processed signal SP related to the second internal signal S2.

According to embodiments, an input signal SI can be inputted to the transmission circuit 120 to generate the first internal signal S1. The radar signal device 100 can further include a processing unit 199 coupled to the transmission circuit 120 and the reception circuit 130 to generate spatial information of an object according to the input signal SI and the processed signal SP. For example, during a time interval, the transmission signal ST can be transmitted continuously and the reception signal SR can be received continuously. The frequencies of the transmission signal ST and the reception signal SR can be corresponding to the frequencies of the input signal SI and the processed signal SP respectively. When the objected moves, a frequency shift is generated according to the Doppler effect. Hence, the processing unit 199 can detect the movement of the object according to the frequency differences between the transmission signal ST and the reception signal SR. When the frequency difference between the transmission signal ST and the reception signal SR is substantially zero, it is determined that the object is still.

The antenna unit 110 can form a first radiation pattern and a second radiation pattern. The first radiation pattern can be used to transmit the transmission signal ST and have a first co-polarized electric field direction E1. The second radiation pattern can be used to receive the reception signal SR and have a second co-polarized electric field direction E2. There is an angle θ1 between the first co-polarized electric field direction E1 and the second co-polarized electric field direction E2. The angle θ1 can be between 45 degrees and 135 degrees, i.e. 45°≤θ1≤135°. For example, the first co-polarized electric field direction E1 can be perpendicular to the second co-polarized electric field direction E2, that is, the angle θ1 can be 90 degrees.

The first opening 118 can enable the first radiation pattern to form a first bi-directional radiation pattern and enable the second radiation pattern to form a second bi-directional radiation pattern. In FIG. 1, each of the bi-directional radiation patterns can be of two directions entering the paper and going out of the paper, where the paper can be of a plane defined by the directions d1 and d2 in FIG. 1. Because the angle θ1 between the first co-polarized electric field direction and the second co-polarized electric field direction is between 45 degrees and 135 degrees (i.e. 45°≤θ1≤135°), the isolation between the transmission signal ST and the reception signal SR is sufficient. Further, since bi-directional radiation patterns can be generated through the first opening 118, the performance of transceiving signals is improved.

In FIG. 1, the first feed structure 111 and the second feed structure 112 can have a modified tuning-fork structure, where the arms of the tuning-fork structure (e.g. the arms 111A and 112A) can be bent. However, FIG. 1 is an example, and embodiments are not limited thereto. In FIG. 1, the arms 111A and 112A are bent to prevent the first feed structure 111 and the second feed structure 112 from contacting one another. If the first feed structure 111 and the second feed structure 112 are formed on different metal layers, and/or are separated by sufficient space, the first feed structure 111 and the second feed structure 112 can have a T-shape without bending their arms. According to other embodiments, each of the first feed structure 111 and the second feed structure 112 can have an L-shape or a linear shape. The arm(s) of the first feed structure 111 and the second feed structure 112 can be bent or unbent. The shapes of the first feed structure 111 and the second feed structure 112 can be the same or different.

In FIG. 1, the antenna unit 110 can include a first conductive portion 117 and a second conductive portion 119. The first conductive portion 117 can surround the second conductive portion 119, so the second conductive portion 119 can be like an island. The first conductive portion 117 and the second conductive portion 119 can be formed on the same metal layer to be coplanar. In another embodiment, the first conductive portion 117 and the second conductive portion 119 can be formed on different metal layers to be not coplanar, where the first conductive portion 117 can be above the second conductive portion 119 or below the second conductive portion 119.

In FIG. 1, two, three or all of the first feed structure 111, the second feed structure 112, the first conductive portion 117 and the second conductive portion 119 can be coplanar (e.g. formed on the same metal layer) or not coplanar (e.g. formed on different metal layers).

If two of the first feed structure 111, the second feed structure 112, the first conductive portion 117 and the second conductive portion 119 are not coplanar, one can be located above the other one. In other words, one of the first feed structure 111, the second feed structure 112, the first conductive portion 117 and the second conductive portion 119 can be formed on an upper metal layer, and the other one of them can be formed on a lower metal layer.

The antenna unit 110 can include or not include the second conductive portion 119. If the antenna unit 110 includes the second conductive portion 119, the slot between the first conductive portion 117 and the second conductive portion 119 can be an annular slot (a.k.a. slot ring). If the antenna unit 110 does not include the second conductive portion 119, the first opening 118 can be an aperture.

In FIG. 1, the annular slot between the first conductive portion 117 and the second conductive portion 119 is a rectangular annular slot. However, FIG. 1 is an example, and embodiments are not limited thereto. The annular slot between the first conductive portion 117 and the second conductive portion 119 can be a circular annular slot or an elliptical annular slot.

The shape of the second conductive portion 119 can be a rectangle, a circle, an ellipse or a suitable shape allowing the second conductive portion 119 to transceive signals properly.

In FIG. 1, if both the first conductive portion 117 and the second conductive portion 119 are formed on the first metal layer 115, the first metal layer 115 can include a first metal sub-layer and a second metal sub-layer, where the first conductive portion 117 can be of the first metal sub-layer, the second conductive portion 119 can be of the second metal sub-layer. The first metal sub-layer can surround the second metal sub-layer. The first opening 118 can be between the first metal sub-layer and the second metal sub-layer to be an annular slot. For example, the first metal sub-layer (e.g. the first conductive layer 117) can be a ground plane having a reference voltage level, and the second metal sub-layer (e.g. the second conductive layer 119) may not be a ground plane. In another embodiment, if the second metal sub-layer is large enough for disposing circuits (e.g. the processing unit 199, the transmission circuit 120 and the reception circuit 130) on the second metal sub-layer, the second metal sub-layer can be a ground plane having a reference voltage level.

The first metal sub-layer of the first metal layer 115 (e.g. the first conductive layer 117) can have a first thickness. The second metal sub-layer of the first metal layer 115 (e.g. the second conductive layer 119) can have a second thickness. The first thickness can be equal to or different from the second thickness. For example, if the first metal layer 115 is a metal layer of a printed circuit board (PCB), the first thickness can be equal to the second thickness. In another example, if the first metal layer 115 is a metal plate component (e.g. iron plate), the first thickness can be different from the second thickness. Appropriate material and thickness can be selected according to the requirements of the process and application.

In some embodiments, the first feed structure 111 and the second feed structure 112 can be isolated from the first conductive portion 117. In other embodiments, at least one of the first feed structure 111 and the second feed structure 112 can be electrically coupled to the first conductive portion 117, for example, through the conductive via(s) of the printed circuit board.

In FIG. 1, the annular slot between the first conductive portion 117 and the second conductive portion 119 is a rectangular annular slot. The first projection of the first feed structure 111 and the second projection of the second feed structure 112 can respectively overlap with a first side slot and a second side slot of the rectangular annular slot. The first side slot can extend along a first direction d1, the second side slot can extend along a second direction d2 perpendicular to the first direction d1, and the first side slot is adjacent to the second side slot. In FIG. 1, the first side slot has a first width W1 along the second direction d2, and the second side slot has a second width W2 along the first direction d1. The first width W1 can be equal to the second width W2.

The locations of the first feed structure 111 and the second feed structure 112 can be described as below. In the top view of FIG. 1, a first reference line L1 can pass through a first feed point C111 of the first feed structure 111 and a centroid C118 of the first opening 118. A second reference line L2 can pass through a second feed point C112 of the second feed structure 112 and the centroid C118 of the first opening 118. An angle θ2 between the first reference line L1 and the second reference line L2 can be between 45 degrees and 135 degrees, i.e. 45°≤θ2≤135°. In the top view, the first feed point C111 can be at a location where a projection of an edge of the first opening 118 and the first feed structure 111 overlap, where the location can be close to the transmission line. In the top view, the second feed point C112 can be at a location where a projection of an edge of the first opening 118 and the second feed structure 112 overlap, and the location can be close to the transmission line.

In FIG. 1, the first projection of the first feed structure 111 and the second projection of the second feed structure 112 do not overlap with the second conductive portion 119. However, in other embodiments, the first projection of the first feed structure 111 and/or the second projection of the second feed structure 112 can overlap with the second conductive portion 119. Further, according to some embodiments, the first feed structure 111 and/or the second feed structure 112 can be electrically connected to the second conductive portion 119. For example, the first feed structure 111 and/or the second feed structure 112 can be electrically connected to the second conductive portion 119 through conductive via(s) of a printed circuit board.

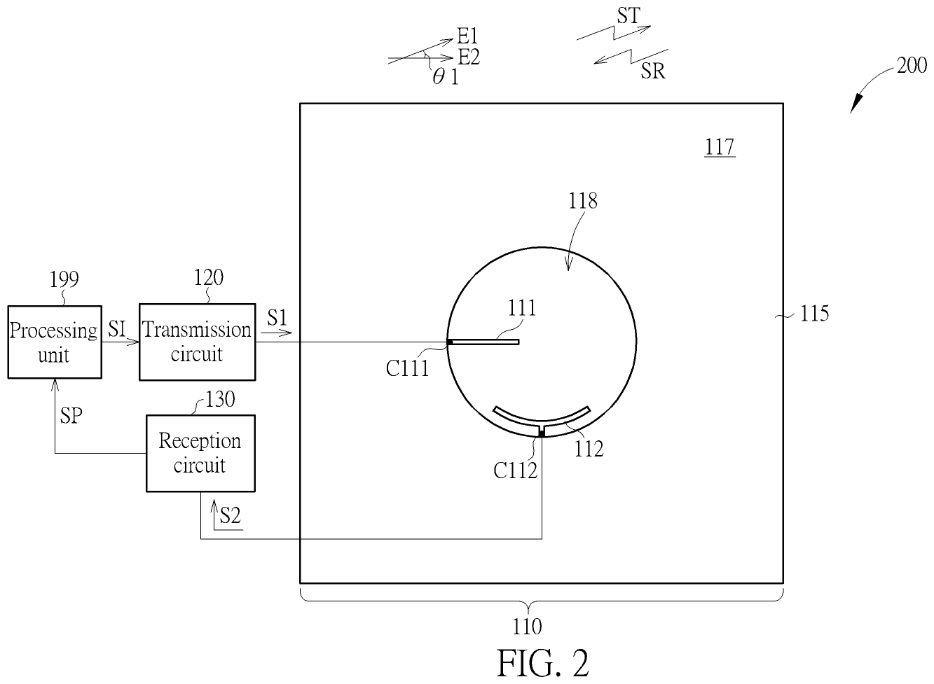

If the antenna 110 does not include the second conductive portion 119, the opening in the first conductive portion 117 (i.e. the first opening 118) can be an aperture, and the aperture can be rectangular, circular or elliptical. In FIG. 2, an embodiment where the first opening 118 is an aperture will be further described.

FIG. 2 illustrates a radar signal device 200 according to another embodiment. FIG. 2 can be a top view for illustration instead of providing accurate size and ratio. The radar signal device 200 can be similar to the radar signal device 100. However, the antenna unit 110 in FIG. 2 does not include the second conductive portion 119, and the first opening 118 can be a circular aperture. In FIG. 2, the first feed structure 111 can have a linear shape, and the second feed structure 112 can be roughly T-shaped. FIG. 2 provides an example to describe a different type of the antenna unit 110. As shown in FIG. 2, the two arms of the second feed structure 112 can be curved corresponding to the shape of the first opening 118, and this is within the scope of embodiments.

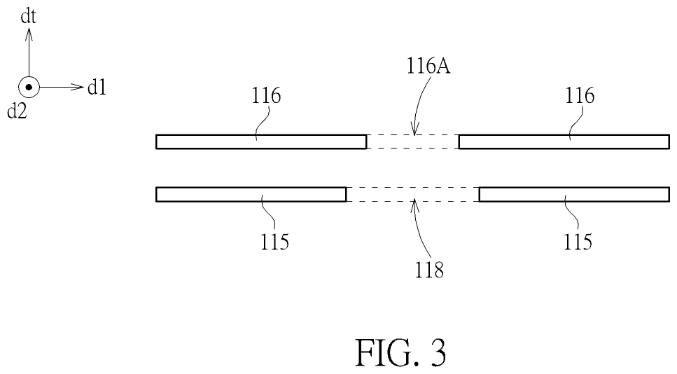

FIG. 3 illustrates that the antenna unit 110 includes the first metal layer 115 and a second metal layer 116 according to an embodiment. FIG. 3 can be a sectional view of FIG. 1 along a section line 3-3′. FIG. 3 is an example for illustration instead of providing accurate size and ratio. In FIG. 3, the antenna unit 110 can further include the second metal layer 116, and the first metal layer 115 and the second metal layer 116 can be arranged along a thickness direction dt. The thickness direction dt can be perpendicular to the first direction d1 and be perpendicular to the second direction d2. As shown in FIG. 2, a second opening 116A can be formed on the second metal layer 116 and pass through the second metal layer 116. A projection of the first opening 118 can at least partially overlap with the second opening 116A to prevent the second metal layer 116 from blocking the first opening 118. According to another embodiment, the projections of the first opening 118 and the second opening 116A can completely overlap with one another. Through the portion where the first opening 118 and the second opening 116A overlap, wireless signals can be transmitted and not blocked to form a bi-directional radiation pattern.

In FIG. 3, the first metal layer 115 can be a ground plane, and the first feed structure 111, the second feed structure 112 and the second metal layer 116 can be coplanar. In other words, the first feed structure 111 and the second feed structure 112 can be formed on the second metal layer 116. In FIG. 3, the second metal layer 116 can be disposed above the first metal layer 115. However, FIG. 3 is an example, and the second metal layer 116 can be disposed below the first metal layer 115 according to other embodiments.

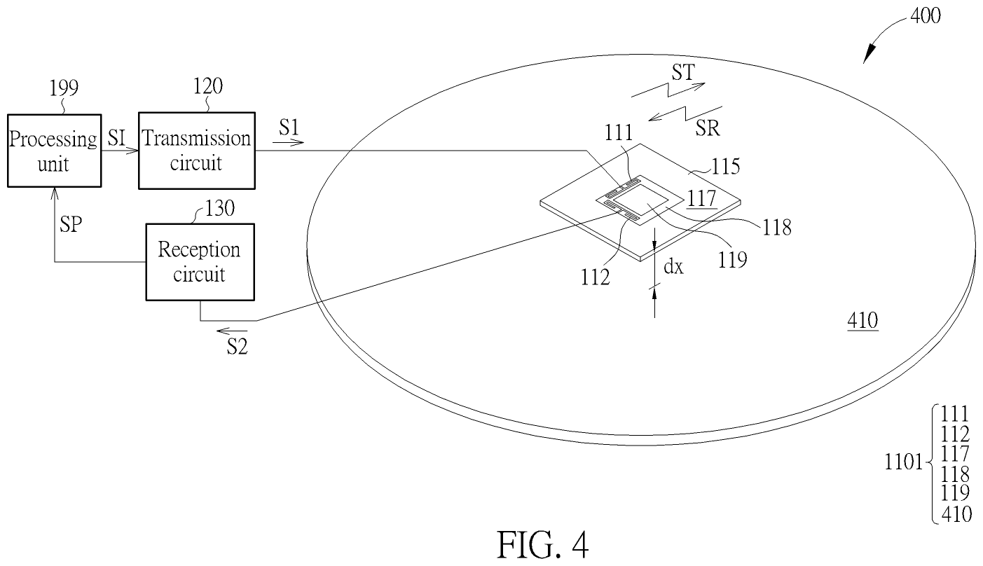

FIG. 4 illustrates a radar signal device 400 according to another embodiment. In FIG. 4, an oblique view is shown. FIG. 4 is for illustration instead of providing accurate size or ratio. The radar signal device 400 can be similar to the radar signal devices 100 and 200 in FIG. 1 and FIG. 2, and the similarities are not repeated. Compared with the radar signal devices 100 and 200, an antenna unit 1101 of the radar signal device 400 can further include a reflector 410. For example, the reflector 410 can reflect the first radiation pattern and the second radiation pattern. Hence, the reflector 410 can enable the first radiation pattern to form a first unidirectional radiation pattern, and enable the second radiation pattern to form a second unidirectional radiation pattern. A distance dx between the reflector 410 and the first metal layer 115 can be between 0.1 and 1 free space wavelength, where the free space wavelength can be the wavelength of one of the transmission signal ST and the reception signal SR in the air. The medium between the reflector 410 and the first metal layer 115 can be air. Hence, bolts, sponges and/or other elements can be used to separate and fix the reflector 410 and the first metal layer 115. In this way, the cost and difficulty of manufacture are reduced. The material of the reflector 410 can be a conductive material able to reflect wireless signals, such as metal.

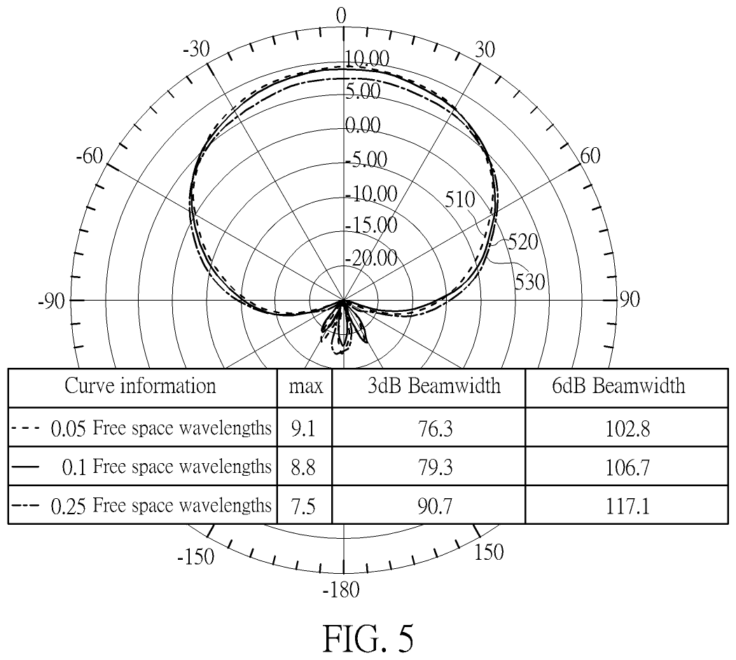

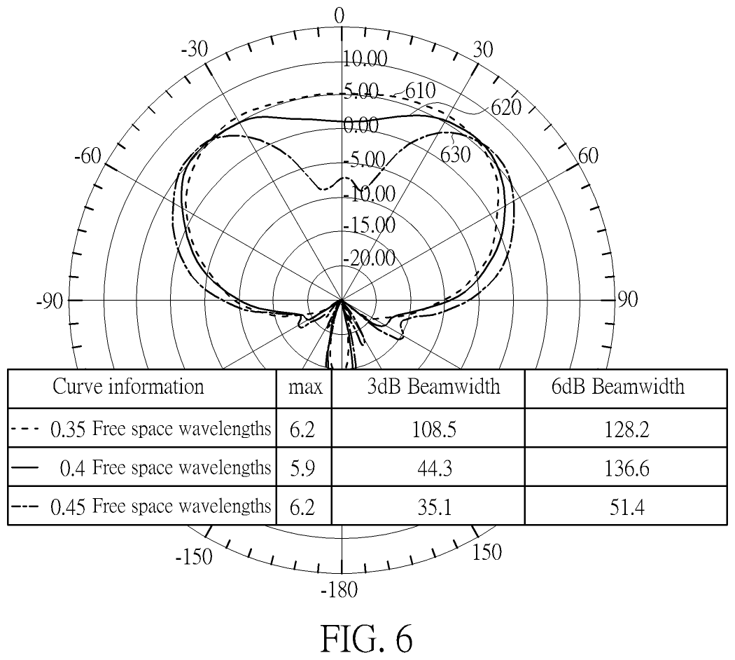

FIG. 5, FIG. 6 and FIG. 7 illustrate antenna patterns of the radar signal device 400 of FIG. 4 according to different embodiments. In FIG. 5 to FIG. 7, the curves 510, 520, 530, 610, 620, 630, 710, 720 and 730 are corresponding to the antenna patterns varying according to different distances dx, as described in Table 1.

TABLE 1

| | FIG. 5 | | | FIG. 6 | | | FIG. 7 | | |
|---|---|---|---|---|---|---|---|---|---|
| | Curve | | | | | | | | |
| | 510 | 520 | 530 | 610 | 620 | 630 | 710 | 720 | 730 |
| Corresponding | 0.05 | 0.1 | 0.25 | 0.35 | 0.4 | 0.45 | 0.5 | 0.6 | 0.8 |
| distance dx (unit: | | | | | | | | | |
| free space | | | | | | | | | |
| wavelength) | | | | | | | | | |

Note:
The distance dx is the distance between reflector 410 and the first metal layer 115.

In the data tables in FIG. 5 to FIG. 7, the field “max” can be the maximum values of the gains of the corresponding curves. The field “3 dB Beamwidth” can be a beam width of 3 dB (decibels). The field “6 dB Beamwidth” can be a beam width of 6 dB (decibels). In FIG. 5 and FIG. 6, when the distance dx increases, the gains corresponding to the left side and right side of the antenna patterns can be larger. Hence, for example, in the environment of a corridor, the radar signal device 400 can be disposed in different positions of the corridor, such as a corner, a center of the corridor, the ceiling and so on to adjust the distance dx to adjust the antenna pattern. By adjusting the distance dx, the antenna pattern can vary accordingly to adjust the detection range to better detect objects in the corridor. In FIG. 5, the antenna gain near 0 degrees is larger, so it may be proper to place the radar signal device 400 at a corner of the corridor. In FIG. 6, the antenna gains near ±45 degrees are larger, so it may be proper to dispose the radar signal device 400 at the center of the corridor. In FIG. 7, the antenna gains at 0 degrees and the left and right sides are larger, so it may be useful for detecting objects in a special scenario or in a space with a special shape.

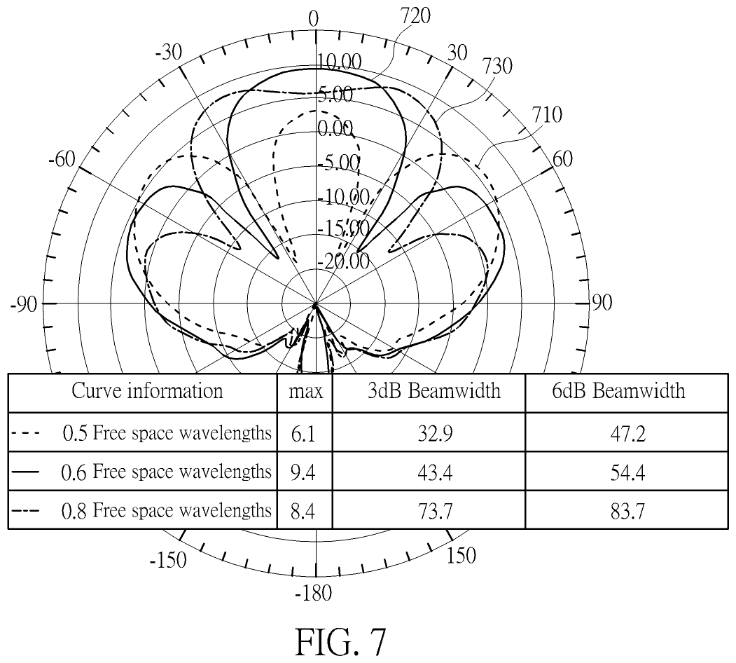

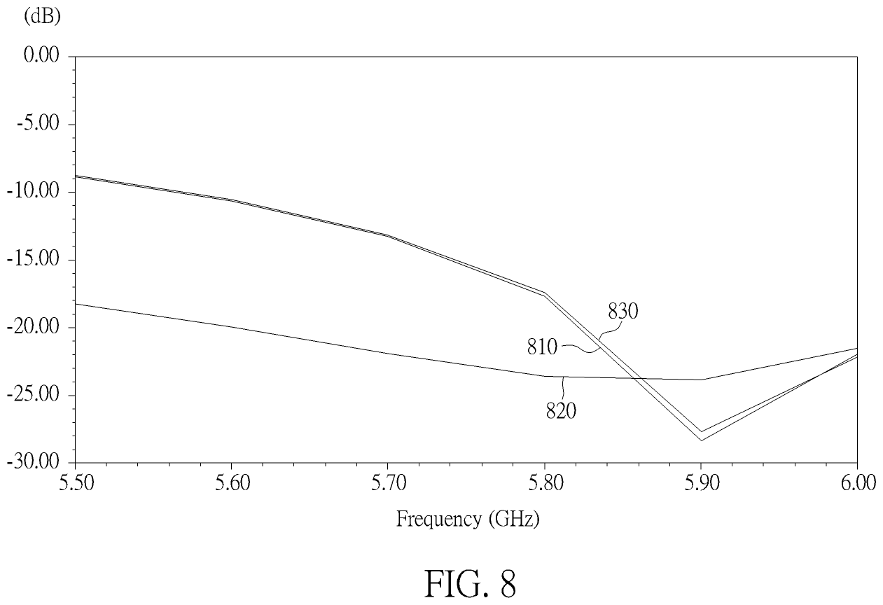

FIG. 8 illustrates the scattering parameters (i.e. S parameters) when the radar signal device 100 in FIG. 1 is used according to an embodiment. In FIG. 8, the curves 810, 820 and 830 can be corresponding to S22 parameter, S21 parameter and S11 parameter respectively. In FIG. 8, the curves 810 and 830 can be used to observe the return losses, and the curve 820 can be used to observe the isolation. In FIG. 8, the S22 parameter and the S11 parameter can be lower than −8.5 dB, and the S21 parameter can be lower than −18 dB. Hence, the return losses are small enough, and the isolation is high enough.

Since the isolation of the antenna unit of the radar signal device is high enough, it is allowed to use an external amplifier (e.g. low noise amplifier, LNA) to amplify the processed signal SP or the second internal signal S2 generated according to the reception signal SR, so as to improve the performance of the radar signal device. In this way, the amplifier in the integrated circuit (IC) for processing the second internal signal S2 can be prevented from being unable to operate normally due to saturation.

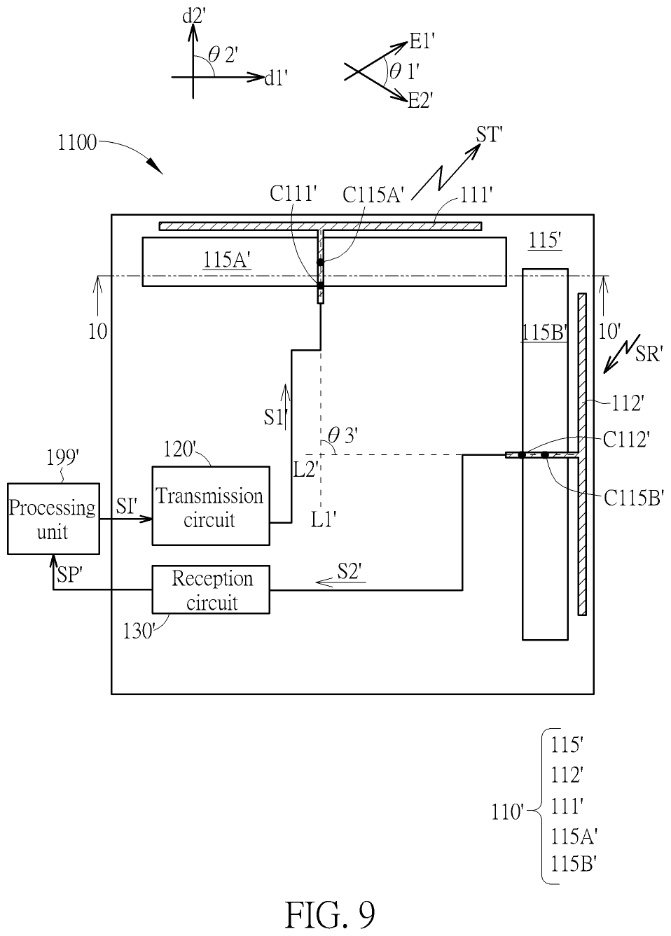

FIG. 9 illustrates a radar signal device 1100 according to another embodiment. FIG. 9 can provide a top view and an example for illustration instead of providing accurate size and ratio, and embodiments are not limited thereto. In FIG. 9, the radar signal device 1100 can include an antenna unit 110′, a transmission circuit 120′ and a reception circuit 130′. The antenna unit 110′ can transmit a transmission signal ST′ and receive a reception signal SR′ concurrently during a time interval. The transmission signal ST′ and the reception signal SR′ can be wireless signals.

The antenna unit 110′ can include a first metal layer 115′, a first feed structure 111′ and a second feed structure 112′. A first opening 115A′ and a third opening 115B′ can be formed on the first metal layer 115′ and pass through the first metal layer 115′. A first projection of the first feed structure 111′ on the first metal layer 115′ can at least partially overlap with the first opening 115A′. The first feed structure 111′ can receive the first internal signal S1′, and the transmission signal ST′ can be generated according to at least the first internal signal S1′. A second projection of the second feed structure 112′ on the first metal layer 115′ can at least partially overlap with the third opening 115B′. The second feed structure 112′ can transmit the second internal signal S2′, and the second internal signal S2′ can be generated according to at least the reception signal SR′. The transmission circuit 120′ can generate the first internal signal S1′. The reception circuit 130′ can generate a processed signal SP′ related to the second internal signal S2′, and the processed signal SP′ can be amplified and/or demodulated by a backend circuit. According to embodiments, the transmission circuit 120′ and the reception circuit 130′ can be different circuits or be integrated as a transceiver circuit. According to some embodiments, the first metal layer 115′ can be a ground plane having a reference voltage level (e.g. 0 volts).

According to embodiments, an input signal SI′ can be inputted to the transmission circuit 120′ to generate the first internal signal S1′. The radar signal device 1100 can further include a processing unit 199′ coupled to the transmission circuit 120′ and the reception circuit 130′ to generate spatial information of an object according to the processed signal SP′ and the input signal SI′. For example, during a time interval, the transmission signal ST′ can be transmitted continuously and the reception signal SR′ can be received continuously. The frequencies of the transmission signal ST′ and the reception signal SR′ can be corresponding to the frequencies of the input signal SI′ and the processed signal SP′. When the objected moves, a frequency shift is generated according to the Doppler effect. Hence, the processing unit 199′ can detect the movement of the object according to the frequency differences between the transmission signal ST′ and the reception signal SR′. When the frequency difference between the transmission signal ST′ and the reception signal SR′ is substantially zero, it is determined that the object is still.

In FIG. 9, the antenna unit 110′ can form a first radiation pattern and a second radiation pattern. The first radiation pattern can be used to transmit the transmission signal ST′ and have a first co-polarized electric field direction E1′. The second radiation pattern can be used to receive the reception signal SR′ and have a second co-polarized electric field direction E2′. There can be an angle θ1′ between the first co-polarized electric field direction E1′ and the second co-polarized electric field direction E2′. The angle θ1′ can be between 45 degrees and 135 degrees, i.e. 45°≤θ1′≤135°. According to an embodiment, the first co-polarized electric field direction E1′ can be perpendicular to the second co-polarized electric field direction E2′, i.e. the angle θ1′ can be 90 degrees.

The first opening 115A′ and the third opening 115B′ can enable the first radiation pattern to form a first bi-directional radiation pattern and enable the second radiation pattern to form a second bi-directional radiation pattern. In FIG. 9, each of the bi-directional radiation patterns can be of two directions entering the paper and going out of the paper, where the paper can be of a plane defined by the directions d1′ and d2′ in FIG. 9. Hence, the antenna unit 110′ is suitable for radar detection applications of a fixed direction.

FIG. 10 illustrates that the antenna unit 110′ includes the first metal layer 115′ and a second metal layer 116′ according to an embodiment. FIG. 10 can be a sectional view of FIG. 9 along a section line 10-10′. FIG. 10 provides an example for illustration instead of providing accurate size and ratio, and embodiments are not limited thereto. In FIG. 10, the first metal layer 115′ and the second metal layer 116′ can be arranged along a thickness direction dt′. The thickness direction dt′ can be perpendicular to the first direction d1′ and be perpendicular to the second direction d2′. The first direction d1′ and the second direction d2′ will be further described below. The second metal layer 116′ can be disposed above the first metal layer 115′. A second opening 116A′ and a fourth opening 116B′ can be formed on the second metal layer 116′. The projections of the first opening 115A′ and the second opening 116A′ can at least partially overlap with one another. The projections of the third opening 115B′ and the fourth opening 116B′ can at least partially overlap with one another. Through the portions where the first opening 115A′ and the second opening 116A′ overlap and the third opening 115B′ and the fourth opening 116B′ overlap, wireless signals can be transmitted without being blocked to form a bi-directional radiation pattern.

According to another embodiment, the projections of the first opening 115A′ and the second opening 116A′ can overlap with one another completely, and the projections of the third opening 115B′ and the fourth opening 116B′ can overlap with one another completely. In this embodiment, since the positional difference between the first opening 115A′ and the second opening 116A′ and the positional difference between the third opening 115B′ and the fourth opening 116B′ need not be considered, less design parameters are needed, and the device structure is relatively simple.

When the double-layer structure in FIG. 10 is used, the first metal layer 115′ can be a ground plane having a reference voltage. The first feed structure 111′, the second feed structure 112′ and the second metal layer 116′ can be coplanar. In other words, the first feed structure 111′ and the second feed structure 112′ can be formed on the second metal layer 116′.

When the metal layer where the first feed structure 111′ and the second feed structure 112′ are formed (e.g. the second metal layer 116′) is different from the first metal layer 115′, the first feed structure 111′ and the transmission circuit 120′ can be connected through a transmission line, and the second feed structure 112′ and the reception circuit 130′ can be connected through a transmission line. The transmission line can include a microstrip, an external wire, a coplanar waveguide (CPW), a grounded CPW or another transmission line that can be implemented between the first metal layer 115′ and each of the first feed structure 111′ and the transmission circuit 120′. Each of the microstrip and the CPW can be formed using a conductive layer of a printed circuit board (PCB). In another embodiment, if the first feed structure 111′ and the second feed structure 112′ are formed on the first metal layer 115′, the first feed structure 111′ and the transmission circuit 120′ can be connected using a CPW, and the second feed structure 112′ and the reception circuit 130′ can be connected using another CPW.

In another embodiment, when one of the first feed structure 111′ and the second feed structure 112′ is formed on a metal layer (e.g. the second metal layer 116′) different from the first metal layer 115′, and the other one of the first feed structure 111′ and the second feed structure 112′ is formed on first metal layer 115′, the feed structure not on the first metal layer 115′ can be connected to an internal circuit (e.g. one of the transmission circuit 120′ and the reception circuit 130′) through a microstrip, an external wire or a transmission line of another type, and the feed structure on the first metal layer 115′ can be connected to the internal circuit (e.g. the other one of the transmission circuit 120′ and the reception circuit 130′) through a CPW.

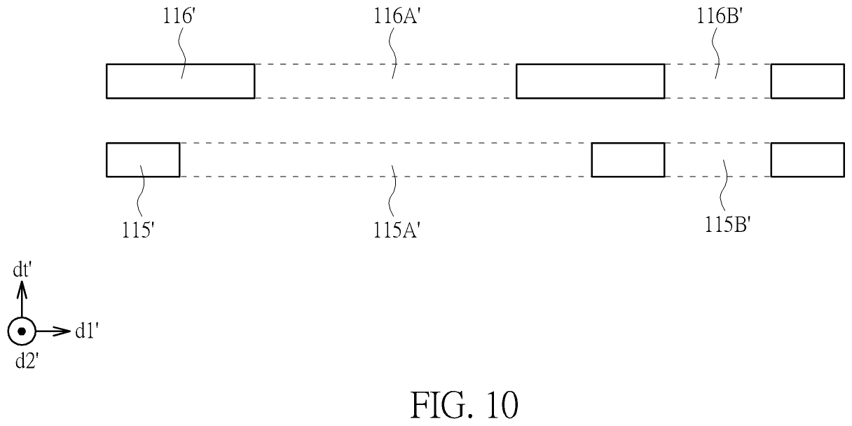

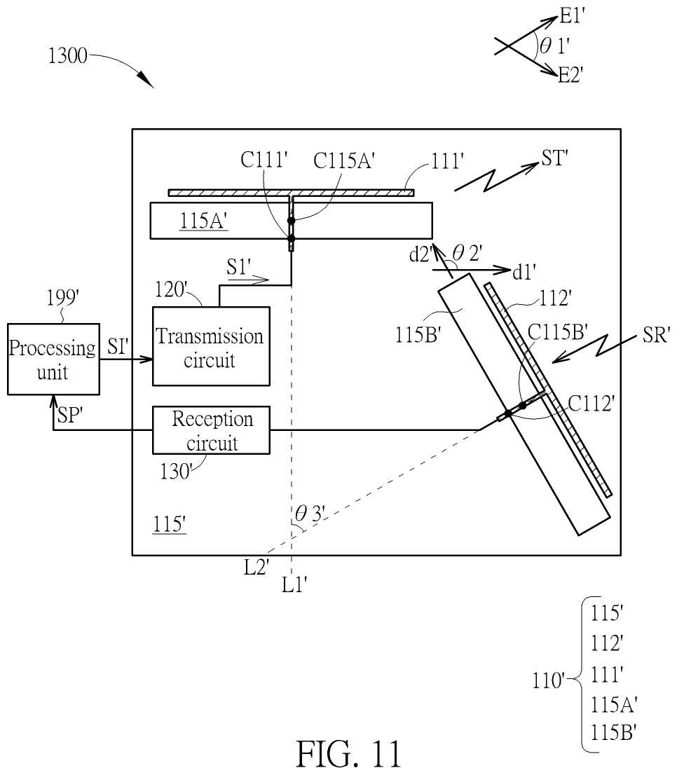

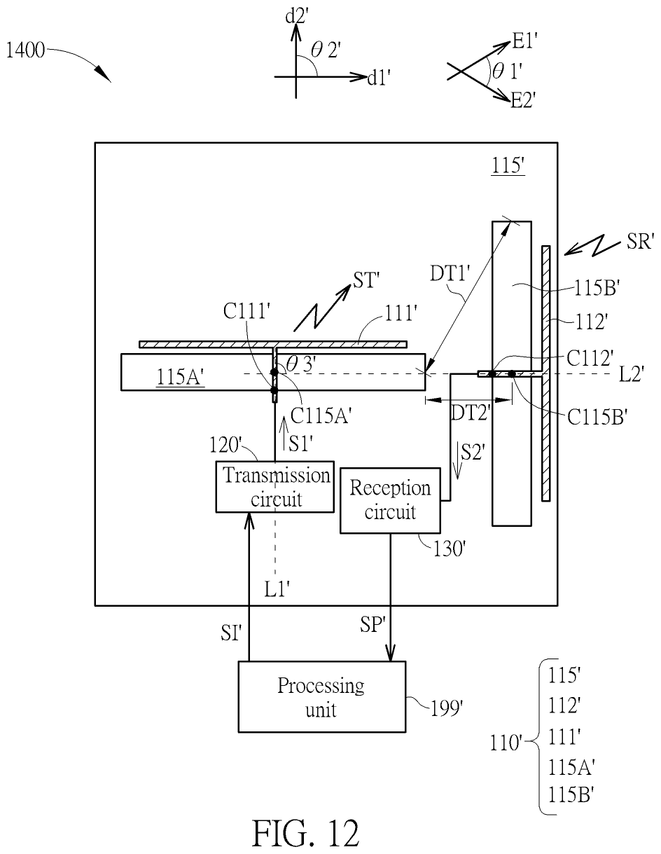

FIG. 11 and FIG. 12 illustrate radar signal devices 1300 and 1400 according to other embodiments. FIG. 11 and FIG. 12 can provide top views for explaining embodiments instead of providing accurate size and ratio. In FIG. 11 and FIG. 12, each of the radar signal devices 1300 and 1400 can include the first opening 115A′, the third opening 115B′, the first feed structure 111′ and the second feed structure 112′. However, the locations of the first opening 115A′, the third opening 115B′, the first feed structure 111′ and the second feed structure 112′ can be different from that in FIG. 9.

In FIG. 9, FIG. 11 and FIG. 12, the first opening 115A′ can be a first rectangular slot, and the third opening 115B′ can be a second rectangular slot. A long side of the first rectangular slot can extend along a first direction d1′. Along side of the second rectangular slot can extend along a second direction d2′. The first direction d1′ and the second direction d2′ are not in parallel. There can be an angle θ2′ between the first direction d1′ and the second direction d2′. For example, the angle θ2′ can be between 45 degrees and 135 degrees, i.e. 45°≤θ2′≤135°.

In FIG. 12, a distance DT1′ can be longer than another distance DT2′. The distance DT1′ can be between a center of a short side of the first rectangular slot (i.e. the first opening 115A′) closer to the second rectangular slot (i.e. the third opening 115B′), and a center of a short side of the second rectangular slot. The distance DT2′ can be between the center of the short side of the first rectangular slot being closer to the second rectangular slot, and a centroid C115B′ of the second rectangular slot. In other words, as shown in FIG. 12, the first opening 115A′ and the third opening 115B′ can be roughly arranged as a T-shape. According to the characteristics of the antenna, since the currents at the edges of the short sides of a rectangular slot are larger, the signals related to two rectangular slots will affect one another when the edges of the short sides of the two rectangular slots are close to one another. With the layout of FIG. 12, the edge of the short side of the first rectangular slot (e.g. the short side of the first opening 115A′) can be farther away from the edge of the short side of the second rectangular slot (e.g. the short side of the third opening 115B′), so the isolation between the transmission signal ST′ and the reception signal SR′ is improved.

As shown in FIG. 9, FIG. 11 and FIG. 12, a first reference line L1′ can pass through a first feed point C111′ of the first feed structure 111′ and a centroid C115A′ of the first opening 115A′. A second reference line L2′ can pass through a second feed point C112′ of the second feed structure 112′ and a centroid C115B′ of the third opening 115B′. An angle θ3′ between the first reference line L1′ and the second reference line L2′ can be between 45 degrees and 135 degrees, i.e. 45°≤θ3′≤135°. In the top view, the first feed point C111′ can be at a location where a projection of an edge of the first opening 115A′ and the first feed structure 111′ overlap, and the location can be close to the transmission line. In the top view, the second feed point C112′ can be at a location where a projection of an edge of the third opening 115B′ and the second feed structure 112′ overlap, and the location can be close to the transmission line.

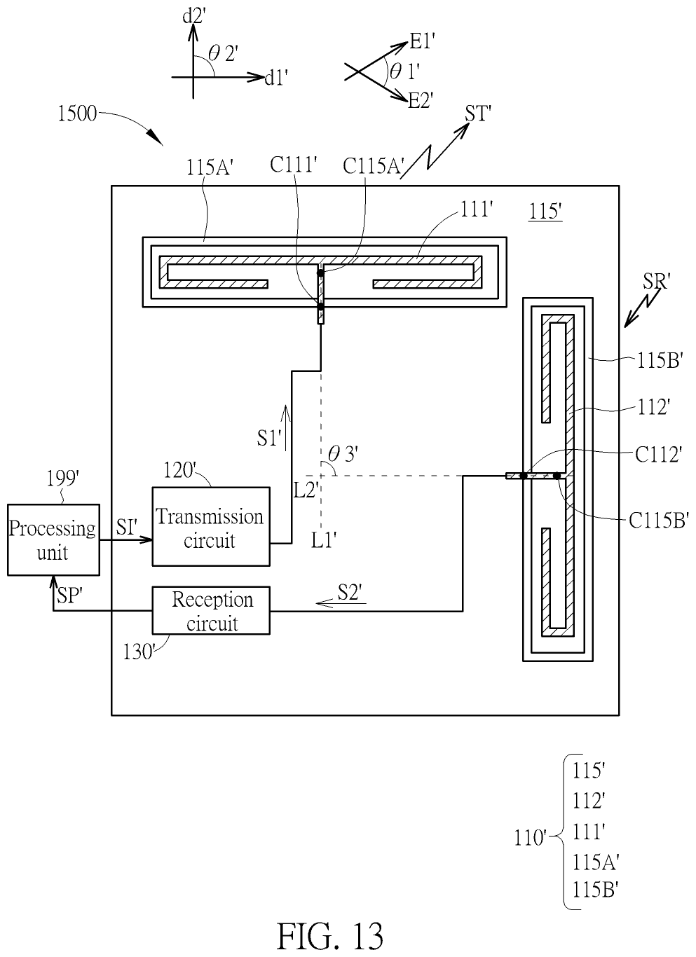

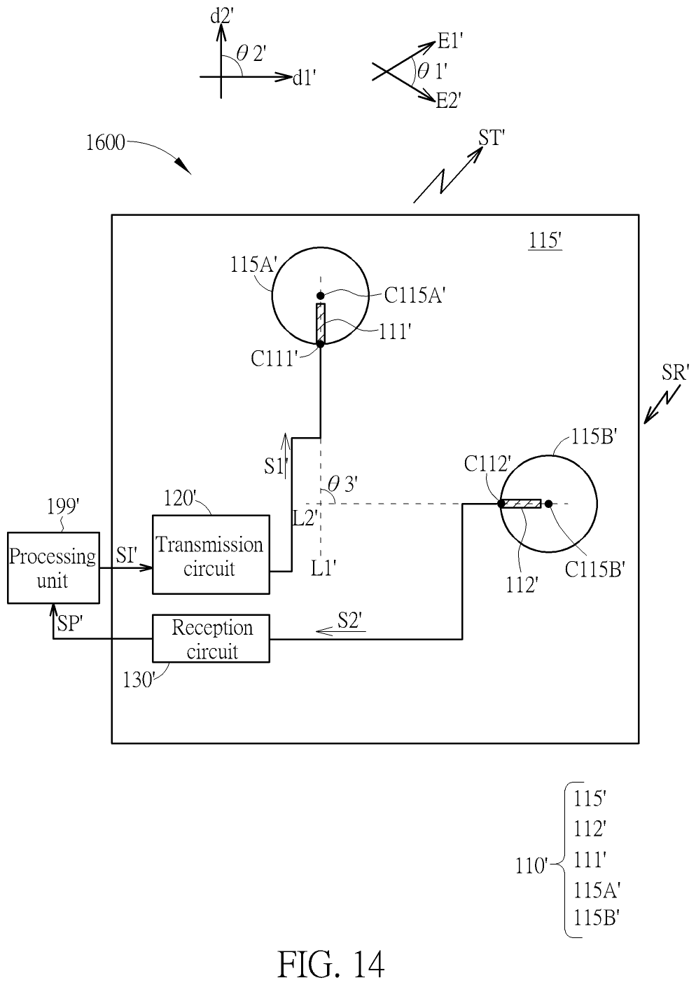

FIG. 13 and FIG. 14 illustrate radar signal devices 1500 and 1600 according to other embodiments. FIG. 13 and FIG. 14 can be top views for describing embodiments instead of providing accurate size and ratio. In FIG. 13, the first opening 115A′ can be a first annular slot (a.k.a. slot ring), and the third opening 115B′ can be a second annular slot. In FIG. 13, the first opening 115A′ and the third opening 115B′ can be rectangular annular slots. However, FIG. 13 is an example, and embodiments are not limited thereto. According to other embodiments, each of the first opening 115A′ and the third opening 115B′ can be a rectangular annular slot, a circular annular slot or an elliptical annular slot.

In FIG. 14, the first opening 115A′ can be a first aperture, and the third opening 115B′ can be a second aperture. In the text, a slot can have a slit shape, and a width of the aperture can be larger than a width of the slot. In FIG. 14, the first opening 115A′ and the third opening 115B′ can be circular apertures, but embodiments are not limited thereto. According to other embodiments, each of the first opening 115A′ and the third opening 115B′ can be a rectangular aperture, a circular aperture or an elliptical aperture.

As shown in FIG. 9 and FIG. 11 to FIG. 14, the first opening 115A′ and the third opening 115B′ can have the same shape. However, according other embodiments, the first opening 115A′ and the third opening 115B′ can have different shapes. For example, the first opening 115A′ can be one of a slot, an annular slot and an aperture, and the third opening 115B′ can be another one of a slot, an annular slot and an aperture. In another example, the shape of the first opening 115A′ can be one of rectangle, circle and ellipse, and the shape of the second opening 115B′ can be another one of rectangle, circle and ellipse. As long as the antenna unit 110′ can properly transmit the transmission signal ST′ and receive the reception signal SR′, the shapes of the first opening 115A′ and the shape of the second opening 115B′ are acceptable.

In FIG. 9, FIG. 11 and FIG. 12, the first feed structure 111′ and the second feed structure 112′ can have a T-shape. In FIG. 13, the first feed structure 111′ and the second feed structure 112′ can have a tuning-fork shape. In FIG. 13, a first projection of the first feed structure 111′ with the tuning-fork shape can be within the range surrounded by the first annular slot (i.e. the first opening 115A′). A second projection of the second feed structure 112′ with the tuning-fork shape can be within the range surrounded by the second annular slot (i.e. third opening 115B′). In FIG. 14, the first feed structure 111′ and the second feed structure 112′ can have a linear shape. Here, FIG. 9 and FIG. 11 to FIG. 14 are examples, and embodiments are not limited thereto. According to embodiments, the shapes of the first feed structure 111′ and the second feed structure 112′ can be the same or different. For example, the shape of the first feed structure 111′ can be one of a linear shape, a T-shape and a tuning-fork shape, and the shape of the second feed structure 112′ can be another one of the linear shape, the T-shape and the tuning-fork shape.

In FIG. 13 and FIG. 14, the locations of the components and openings of the radar signal devices 1500 and 1600 can be similar to that in FIG. 9. However, FIG. 9 and FIG. 11 to FIG. 14 are examples, and embodiments are not limited thereto. According to embodiments, when the layouts of FIG. 9, FIG. 11 and FIG. 12 are used, each of the first opening 115A′ and the third opening 115B′ can be a slot, an aperture or an annular slot, each of the first opening 115A′ and the third opening 115B′ can be rectangular, circular or elliptic, and each of the first feed structure 111′ and the second feed structure 112′ can have a T-shape, a tuning-fork shape or a linear shape. As long as the radar signal device can normally transmit the transmission signal ST′ and receive the reception signal SR′, the shapes and locations of the components and the openings can be adjusted according to experiments and simulations.

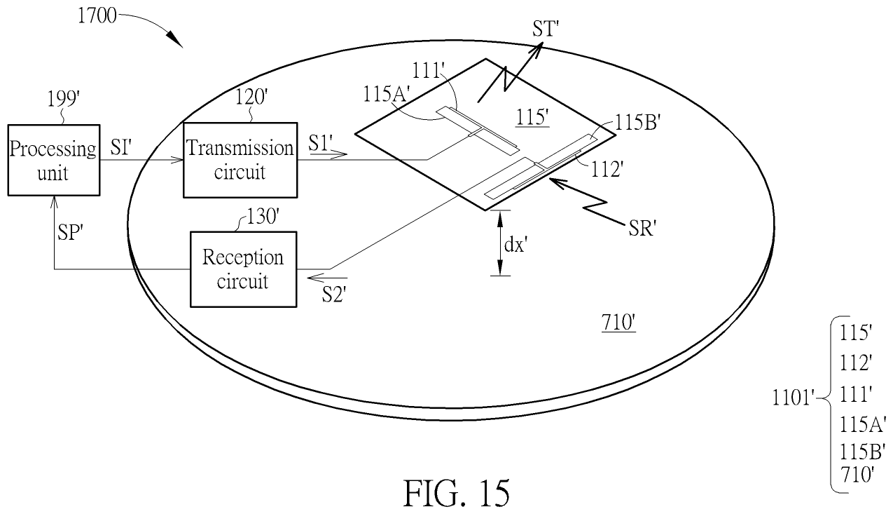

FIG. 15 illustrates a radar signal device 1700. The antenna unit 1101′ in FIG. 15 can be similar to the antenna unit 110′ in FIG. 12. However, the antenna unit 1101′ in FIG. 15 can further include the reflector 710′. As shown in FIG. 15, the reflector 710′ can be disposed below the first metal layer 115′. For example, the reflector 710′ can reflect a first radiation pattern to form a first unidirectional radiation pattern, and reflect a second radiation pattern to form a second unidirectional radiation pattern. A distance dx′ between the reflector 710′ and the first metal layer 115′ can be between 0.1 and 1 free space wavelength. The free space wavelength can be the wavelength of one of the transmission signal ST′ and the reception signal SR′ in the air. Through the reflector 710′, the antenna pattern can be adjusted for the applications. In FIG. 15, the antenna unit 1101′ can be similar to the antenna unit 110′ in FIG. 12. FIG. 15 is an example. According to embodiments, each of the antenna units 110′ in FIG. 9 and FIG. 11 to FIG. 14 and abovementioned antenna units can further include the reflector 710′ to adjust the antenna pattern. Between the first metal layer 115′ and the reflector 710′, bolts, sponges and/or other elements can be disposed to separate and fix the reflector 710′ and the first metal layer 115′.

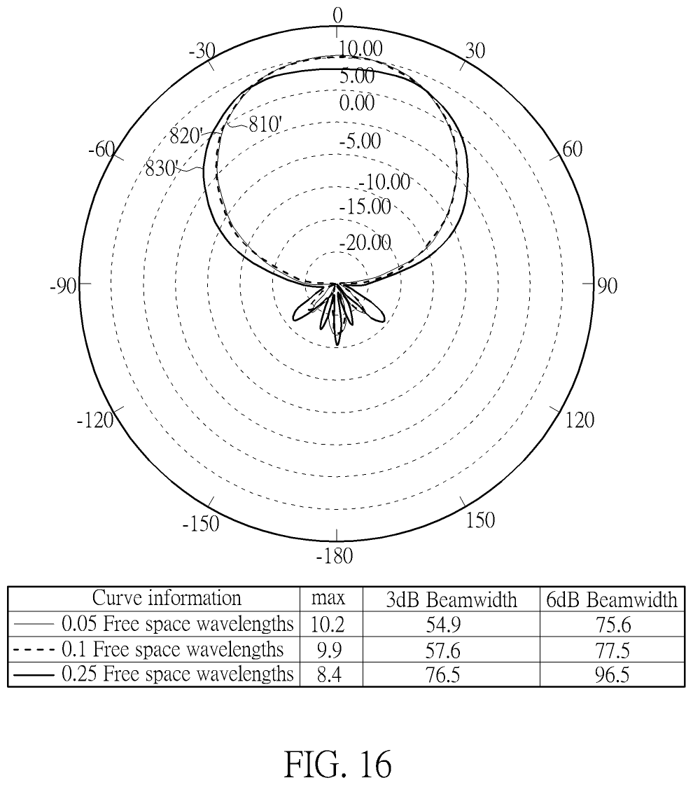

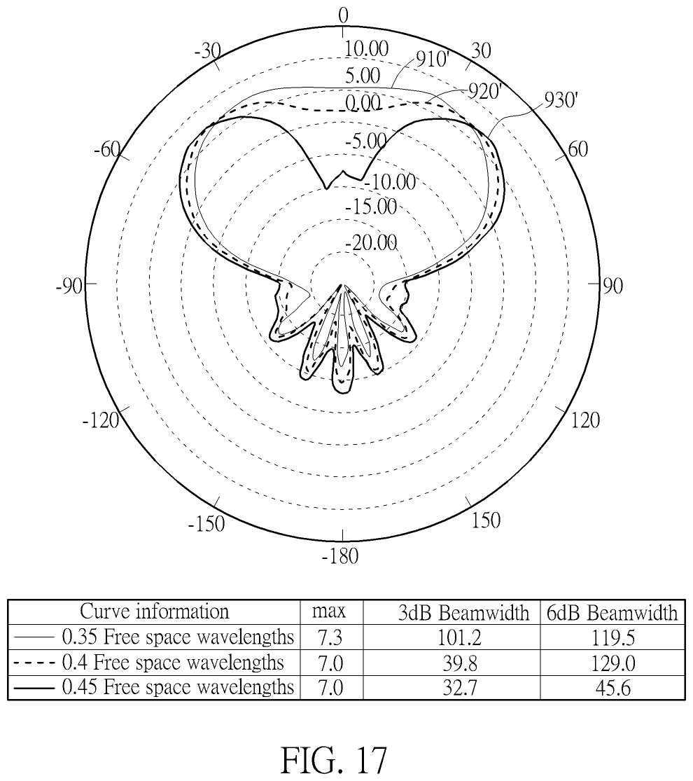

FIG. 16 and FIG. 17 illustrate antenna patterns of the radar signal device 1700 in FIG. 15 according to different embodiments. In FIG. 16 and FIG. 17, the curves 810′, 820′, 830′, 910′, 920′ and 930′are corresponding to different antenna patterns varying according to different distances dx, as mentioned in Table 2.

TABLE 2

| | FIG. 16 | | | FIG. 17 | | |
|---|---|---|---|---|---|---|
| | Curve | | | | | |
| | 810′ | 820′ | 830′ | 910′ | 920′ | 930′ |
| Corresponding distance dx′ | 0.05 | 0.1 | 0.25 | 0.35 | 0.4 | 0.45 |
| (unit: free space wavelength) | | | | | | |

Note:
The distance dx′ is the distance between reflector 710′ and the first metal layer 115′.

In the data tables in FIG. 16 and FIG. 17, the field “max” can be the maximum values of the gains of the corresponding curves. The field “3 dB Beamwidth” can be a beam width of 3 dB (decibels). The field “6 dB Beamwidth” can be a beam width of 6 dB (decibels). In FIG. 16 and FIG. 17, when the distance dx′ increases, the gains corresponding to the left side and right side of the antenna patterns can be larger. Hence, for example, in the environment of a corridor, the radar signal device 1700 can be disposed in different positions of the corridor, such as a corner, a center of the corridor, the ceiling and so on to adjust the distance dx′ to adjust the antenna pattern. By adjusting the distance dx′, the antenna pattern can vary accordingly to adjust the detection range to better detect objects in the corridor.

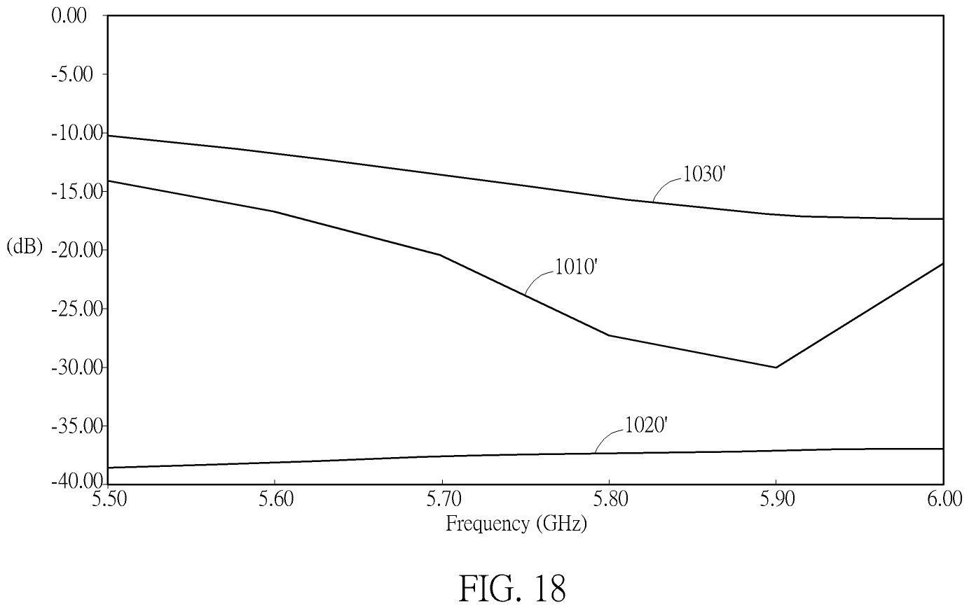

FIG. 18 illustrates the scattering parameters (i.e. S parameters) when the radar signal device 1300 in FIG. 11 is used according to an embodiment. In FIG. 18, the curves 1010′, 1020′ and 1030′ can be corresponding to S22 parameter, S21 parameter and S11 parameter respectively. In FIG. 18, the curves 1010′ and 1030′ can be used to observe the return losses, and the curve 1020′ can be used to observe the isolation. In FIG. 18, the S22 parameter and the S11 parameter can be lower than −10 dB, and the S21 parameter can be lower than −35 dB. Hence, the return losses are small enough, and the isolation is high enough.

Since the isolation of the antenna unit of the radar signal device is high enough, it is allowed to use an external amplifier (e.g. low noise amplifier, LNA) to amplify the processed signal SP′ or the second internal signal S2′ generated according to the reception signal SR′. Hence, the performance of the radar signal device is improved. In this way, the amplifier in the integrated circuit (IC) for processing the second internal signal S2′ can be prevented from being unable to operate normally due to saturation.

In summary, through the radar signal devices 100, 200, 1100, 1300, 1400, 1500 and 1600 and the antenna units 110 and 110′ of various types mentioned above, radar signal devices having bi-directional radiation patterns are implemented. The isolation and return losses of the antenna units of the radar signal devices are within preferable ranges. Further, the areas and volumes of the radar signal devices 100, 200, 1100, 1300, 1400, 1500 and 1600 are small enough. Moreover, through the radar signal devices 400 and 1700 and the antenna units 1101 and 1101′, since the distance dx between the reflector 410 and the first metal layer 115 and the distance dx′ between the reflector 710′ and the first metal layer 115′ can be adjusted to a length between 0.1 to 1 free space wavelength, the antenna patterns can be adjusted using the reflector according to the requirements of environment, and special antenna patterns can be realized for object detection in various environments. In addition, the medium between the reflector 410 and the first metal layer 115 and the medium between the reflector 710′ and the first metal layer 115′ can be air, so the cost and difficulty of manufacture are reduced. As a result, the radar signal devices can improve performance and overcome problems in the field.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radar signal device comprising:
an antenna unit configured to transmit a transmission signal and receive a reception signal concurrently during a time interval, the antenna unit comprising:
a first metal layer where a first opening is formed on the first metal layer, and the first opening passes through the first metal layer;
a first feed structure configured to receive a first internal signal, where the transmission signal is generated according to at least the first internal signal, and a first projection of the first feed structure on the first metal layer at least partially overlaps with the first opening; and
a second feed structure configured to transmit a second internal signal, where the second internal signal is generated according to at least the reception signal, and a second projection of the second feed structure on the first metal layer at least partially overlaps with the first opening;
a transmission circuit configured to generate the first internal signal; and
a reception circuit configured to generate a processed signal related to the second internal signal;
wherein the antenna unit is configured to form a first radiation pattern and a second radiation pattern, the first radiation pattern is used to transmit the transmission signal and has a first co-polarized electric field direction, the second radiation pattern is used to receive the reception signal and has a second co-polarized electric field direction, and an angle between the first co-polarized electric field direction and the second co-polarized electric field direction is between 45 degrees and 135 degrees.

2. The radar signal device of claim 1, wherein the antenna unit further comprises a second metal layer, the first metal layer and the second metal layer are arranged along a thickness direction, a second opening is formed on the second metal layer, and the first opening at least partially overlaps with the second opening.

3. The radar signal device of claim 2, wherein the first metal layer is a ground plane, and the first feed structure, the second feed structure and the second metal layer are coplanar.

4. The radar signal device of claim 1, wherein the first metal layer comprises a first metal sub-layer and a second metal sub-layer, the first metal sub-layer surrounds the second metal sub-layer, and the first opening is located between the first metal sub-layer and the second metal sub-layer to form an annular slot.

5. The radar signal device of claim 4, wherein the first metal sub-layer is a ground plane.

6. The radar signal device of claim 4, where the annular slot is a rectangular annular slot, the first projection of the first feed structure and the second projection of the second feed structure respectively overlap with a first side slot and a second side slot of the rectangular annular slot, the first side slot extends along a first direction, the second side slot extends along a second direction perpendicular to the first direction, and the first side slot is adjacent to the second side slot.

7. The radar signal device of claim 6, wherein the first side slot has a first width along the second direction, the second side slot has a second width along the first direction, and the first width is equal to the second width.

8. The radar signal device of claim 1, wherein the first co-polarized electric field direction is perpendicular to the second co-polarized electric field direction.

9. The radar signal device of claim 1, wherein the first opening is configured to enable the first radiation pattern to form a first bi-directional radiation pattern and enable the second radiation pattern to form a second bi-directional radiation pattern.

10. The radar signal device of claim 1, wherein the antenna unit further comprises a reflector, a distance between the reflector and the first metal layer is between 0.1 and 1 free space wavelength, and the reflector is configured to enable the first radiation pattern to form a first unidirectional radiation pattern and enable the second radiation pattern to form a second unidirectional radiation pattern.

11. The radar signal device of claim 1, wherein a first reference line passes through a first feed point of the first feed structure and a centroid of the first opening, a second reference line passes through a second feed point of the second feed structure and the centroid of the first opening, and an angle between the first reference line and the second reference line is between 45 degrees and 135 degrees.

12. A radar signal device comprising:
an antenna unit configured to transmit a transmission signal and receive a reception signal concurrently during a time interval, the antenna unit comprising:
a first metal layer, where a first opening and a third opening are formed on the first metal layer and pass through the first metal layer;
a first feed structure configured to receive a first internal signal, where the transmission signal is generated according to at least the first internal signal, and a first projection of the first feed structure on the first metal layer at least partially overlaps with the first opening; and
a second feed structure configured to transmit a second internal signal, where the second internal signal is generated according to at least the reception signal, and a second projection of the second feed structure on the first metal layer at least partially overlaps with the third opening;
a transmission circuit configured to generate the first internal signal; and
a reception circuit configured to generate a processed signal related to the second internal signal;
wherein the antenna unit is configured to form a first radiation pattern and a second radiation pattern, the first radiation pattern is used to transmit the transmission signal and has a first co-polarized electric field direction, the second radiation pattern is used to receive the reception signal and has a second co-polarized electric field direction, and an angle between the first co-polarized electric field direction and the second co-polarized electric field direction is between 45 degrees and 135 degrees.

13. The radar signal device of claim 12, the antenna unit further comprises a second metal layer, the first metal layer and the second metal layer are arranged along a thickness direction, a second opening and a fourth opening are formed on the second metal layer, the first opening at least partially overlaps with the second opening, and the third opening at least partially overlaps with the fourth opening.

14. The radar signal device of claim 13, wherein the first metal layer is a ground plane, and the first feed structure, the second feed structure and the second metal layer are coplanar.

15. The radar signal device of claim 12, wherein the first opening is a first rectangular slot extending along a first direction, the third opening is a second rectangular slot extending along a second direction, and the first direction and the second direction are not in parallel.

16. The radar signal device of claim 15, wherein a first distance from a short side of the first rectangular slot to a short side of the second rectangular slot is longer than a second distance from the short side of the first rectangular slot to a centroid of the second rectangular slot.

17. The radar signal device of claim 12, wherein the first co-polarized electric field direction is perpendicular to the second co-polarized electric field direction.

18. The radar signal device of claim 12, wherein the first opening and the third opening are configured to enable the first radiation pattern to form a first bi-directional radiation pattern, and the first opening and the third opening are configured to enable the second radiation pattern to form a second bi-directional radiation pattern.

19. The radar signal device of claim 12, wherein the antenna unit further comprises a reflector, a distance between the reflector and the first metal layer is between 0.1 and 1 free space wavelength, and the reflector is configured to enable the first radiation pattern to form a first unidirectional radiation pattern and enable the second radiation pattern to form a second unidirectional radiation pattern.

20. The radar signal device of claim 12, wherein a first reference line passes through a first feed point of the first feed structure and a centroid of the first opening, a second reference line passes through a second feed point of the second feed structure and a centroid of the third opening, and an angle between the first reference line and the second reference line is between 45 degrees and 135 degrees.
